(19) United States
(12) Patent Application Publication
(10) Pub. No.: US 2025/0101905 A1
(43) Pub. Date: Mar. 27, 2025

(54) Using a fluid as a virtual piston to secondary compression for an internal combustion engine

(71) Applicant: Abdelhakim LIMANE, Saint-Laurent, CA (US)

(72) Inventor: Abdelhakim LIMANE, Saint-Laurent, CA (US)

(21) Appl. No.: 18/129,894

(22) Filed: Apr. 2, 2023

(51) Int. Cl. F02B 47/04; F02B 19/16; F02B 23/08

(52) U.S. Cl. CPC F02B 47/04; F02B 19/16; F02B 23/08

(57) ABSTRACT

The invention relates a system for an internal combustion engine using a fluid as a virtual fast piston with variable stroke. This system enables the engine to behave like a variable compression ratio engine. It consists of a duct relatively long and narrow serving as a cylinder for the virtual piston and opening into a valve. This duct is an extension of the clearance volume in the cylinder head of the engine. When the piston arrive near to the top dead center, a second compression of the air/fuel mixture is carried out by introducing a fluid at high-pressure via a valve. The introduction of fluid in a duct is manifested as a jet of fluid without mixing with the air/fuel mixture. This system allows regardless of the load, to regulate the pressure at the ignition of combustion and to increase the quantity of matter in the cylinder, despite the air/fuel mixture is close to Stochiometric proportions.

### SUMMARY OF THE INVENTION

The present invention relates to a system for improving the energy efficiency and reducing polluting emissions applied to all types of internal combustion engines, whether it is with spark plug, homogeneous-charge compression-ignition (HCCI) or Diesel, by using a fluid as a second piston for compression.

In the latter years, several innovations have been carried out to improve the energy efficiency and to reduce the polluting emissions of the internal combustion engines. Among these, the downsizing with turbocharger, the adoption of the direct injection and the recirculation of the burnt exhaust gases (EGR) that allows cooling the admitted air, creating a stratified mixture and control the oxygen level at low-load. However, it should be noted that on the one hand, these solutions cannot meet the environmental standards requirements. On the other hand, the operation at low revolution per minute (RPM) and low load have been favored over that at high RPM and full load, in addition to the problem of unreliability resulting there from.

Indeed, the engines with variable compression ratios which adapt according to the load are among desired innovations. but, most of the breakthroughs are totally mechanical, the consequences of which linked to the moving parts are not negligible, such as the increasing of the weight, the friction, the size, the number of moving parts and as well as the high position of the center of gravity. Moreover, there are many studies that are very interested in the development of an HCCI engine, where the main issue to be raised is to be able to control the moment when the detonation is engaged regardless of the load.

### DETAILED DESCRIPTION OF THE INVENTION

The present invention provides a modification in the clearance volume of the internal combustion engine with the addition of an extension as duct in the cylinder head (2). The shape of this duct is relatively long and has relatively small cross-section surface. This duct opens onto a micro-valve (3) controlled by the engine control unite (ECU). The operation of the engine will be unchanged.

Indeed, once the essential compression has done by the piston (1), the air/fuel mixture (or air only for diesel engines) is essentially confined in the clearance volume (4 and 5). At this time, the second compression occurs by the introduction of a fluid by the micro-valve (3). This micro-valve can be equated with a valve or an injector controlled by the ECU. This fluid will expel the air/fuel mixture from a long and narrow duct of the clearance volume (5), so as to concentrate it almost completely at the lower part of the clearance volume (4), until to reach the pressure and/or temperature desired regardless of the load.

The scale of the vortex structures is conditioned by the cross-section surface of the duct. In other hand, the contact between the introduced fluid and the air/fuel mixture takes place in a location (5) with a relatively small cross-section surface and little divergent in the direction of the flow. For that reason, the mixing of the fluid with the air/fuel mixture is extremely limited or even impossible. In addition, the burnt gases of the preceding cycle stuck in the duct of the clearance volume (5) insulate the air/fuel mixture from the fluid. In view of these facts, the fluid will have the effect of a fast piston with variable stroke and depends on the quantity of the fluid introduced. In other words, depends on the opening time of the micro-valve (3). Consequently, the engine behaves like a variable compression ratio engine. However, the heating of the air/fuel mixture by compression by introduction of the fluid is carried out even if the fluid introduced is relatively cold.

The present invention also allows to control the moment of auto-ignition for the HCCI engine and to achieve the conditions of auto-ignition at less lean and closer to stoichiometry proportions, regardless of the load for all types of engines. On the other hand, this invention increases both the quantity of matter in the cylinder while being at proportions close to the stoichiometry (air+fuel+fluid) and the size of the clearance volume relative to the swept volume (the addition of the duct (5)). Therefore, it decreases the compression ratio (volumetric ratio) of the engine without decreasing the pressure ratio. At the moment of combustion, the temperature peak will not be as high as if the compression ratio was higher and the quantity of matter was less. Consequently, the pollutants such as nitrogen oxides (NOx) and carbon monoxide (CO) will be greatly reduced.

Moreover, the present invention allows the engines to operate with a cycle close to Sabathe cycle (mixed cycle) without supply of extra heat in expansion. Indeed, during expansion, the introduced fluid which was extremely dense mixes with the burnt gases and absorbs the combustion heat energy. Thus, the temperature of the gases decreases and the pressure level stays high longer, despite the total volume of the gases increasing. Therefore, the torque increases, and the energy efficiency of the engine improves.

The lower part of the clearance volume is called the combustion chamber (4). It is here where the air/fuel mixture is essentially located at the time of ignition. The higher part of the clearance volume which looks like a duct is called the compression chamber (5). There is no combustion into the compression chamber (5) particularly in the portion near the micro-valve (3), due to the absence of fuel. The lower part of the compression chamber (5) adjacent to the combustion chamber may be the extension of the combustion chamber according to the various parameters, such as the load, the temperatures and the pressures of the air/fuel mixture and of the compression-fluid. The compression chamber may be provided with fins in order to have the least turbulent flow possible, to limit as much as possible the mixture between the compression-fluid and the air/fuel mixture.

It is the ECU which manages the moment of compression-fluid introduction into the compression chamber (5), according to the various parameters as the compression-fluid pressure. If the engine is Diesel type or uses spark plug for ignition, the compression-fluid pressure can be lower than the combustion pressure peak, because the micro-valve (3) for introducing the compression-fluid can be closed when the combustion starts. If the engine is HCCI type, there are two cases:
If the compression-fluid pressure is greater than the combustion pressure peak, the micro-valve (3) may be open when the combustion is engaged. As a result, the introduction of the fluid may be delayed until the piston (1) exceeds the top dead center.
If the compression-fluid pressure is lower than the combustion pressure peak, the micro-valve (3) must be closed at the time of combustion. The introduction of the fluid must be advanced and the engagement of the combustion will be caused by the compression by the piston (1) when it reaches the top dead center.

The compression-fluid will be used to recover a portion of heat energy of the burnt gases exhausted from the engine, before introducing it into the compression chamber (5) in order to reach relatively cold temperatures regarding of the combustion, but hot enough to ensure combustion under the good conditions. For this purpose, an electric heating is provided to adjust the temperature particularly during the cold start-up phases upstream of the micro-valve (3).

Several fluids can be used such as exhaust gases, ambient air, liquid nitrogen and water. The essential steps that the compression-fluid follow before introducing it into the compression chamber (5) are as follows:
Low-pressure compression-fluid intake.
Generating the high pressure of the compression-fluid by at least one compressor or a pump.
Accumulation of the high-pressure compression-fluid in a reservoir.
Heating of the compression-fluid at high pressure by the exhaust gases of the engine.
Electric heating if there is insufficient heat.
Introducing the compression-fluid into the compression chamber (5) of the engine.

If the compression-fluid is liquid before heating (water or liquid nitrogen), the high pressure is generated using a high-pressure pump. In the case where the compression-fluid is gas before heating (exhaust gas or ambient air), the high pressure is generated using at least one high-pressure compressor. The compression must be cool to limit the work expended on compression.

A reservoir for storing the compression-fluid under high pressure is also necessary. Moreover, because of having high-pressure fluid in reservoirs, it is possible to use it in order to operate the micro-valve (3) with high accuracy. On other hand, this micro-valve (3) is already very light and small and it use to ensure a head loss of the fluid flow and thus, to limit as much as possible the leaks when it is closed. However, the sealing of the reservoir to preserve the pressure of the fluid is ensured by other valves that actuate as soon as the engine is stopped.

In the case where the fluid is in gaseous state at low pressure and the high-pressure of fluid is generated by auxiliary compressors separate from the engine. This provides the following advantages:
It is possible to recover some of the kinetic energy of the vehicle in the form of compressed gas using the compressor as a brake.
The engine can be operated as a pneumatic motor without fuel consumption at times when excess compressed gas is available.
It is possible to cool the engine by the compressed gas from the inside by operating it as a pneumatic motor.

If the fluid is air, despite the air containing 20% DI-oxygen (O₂), this does not pose a problem of excess DI-oxygen for the combustion reaction or for the production of NOₓ. Since during the combustion, this air is isolated in the compression chamber (5) and relatively cold. In addition, the air which serves as an oxidizer perfectly mixed with the fuel is confined essentially in the combustion chamber (4) at stoichiometry proportions and well conditions for combustion.

In the case where the compression-fluid is DI-nitrogen (N₂), exhaust gas or air, the fluid is in supercritical state whether upstream of the micro-valve (3) in the high-pressure or downstream generation circuit, after the introduction of the fluid where it undergoes expansion.

In the case where the compression-fluid is water, (the water is more practical on the large installations whose exhaust gas temperature is quite high and stable). There are two cases:
The case where the water is in the liquid or supercritical state upstream of micro-valve (3). The pressure must be greater than 221.20 bars. The heat exchanger is simple without phase change. The micro-valve (3) is assimilated to an injector. The water becomes a mixture of steam and liquid, once has been introduced in the compression chamber (5) and having undergone expansion.
The case where the water is in super-heated steam state upstream of micro-valve (3), the pressure is less than 221.20 bars. The heat exchanger is a boiler with liquid and vapor phase separation. The micro-valve (3) for introducing the water into the compression chamber is assimilated to a valve.

Finally, a significant portion of the energy spent for the second compression by fluid will come from the heat energy recovered from the exhaust gases, in particular when the fluid is liquid nitrogen. This will contribute to improve the energy efficiency of the engine as well as to the reduction of the carbon dioxide CO2 produced.

In summary, the present invention improves the overall energy efficiency of the engine and limits the polluting emissions produced without modifying the general structure and the operation of the internal combustion engine, by the following characteristics:
Converting a more heat energy of combustion into mechanical work.
Generating a more optimal pressure and temperature for the combustion for any type of an internal combustion engines, regardless of the load.
Recovering part of the heat energy of the exhaust gases.
Recovering part of the kinetic energy during braking.
Saving part of the work required to the compression.
Decreasing the temperature peak of combustion.
Ignition of the combustion by a compression for HCCI engines.
Controlling the moment of auto-ignition for HCCI engines.
Operating the Diesel and HCCI engines with a proportion that are less lean and close to stoichiometry.

### BRIEF DESCRIPTION OF DRAWINGS

FIG. 1 represents a cross-section of a four-stroke engine where (1) is the piston, (2) is the cylinder head with the duct of the clearance volume and (3) is the micro-valve for introducing the compression-fluid.

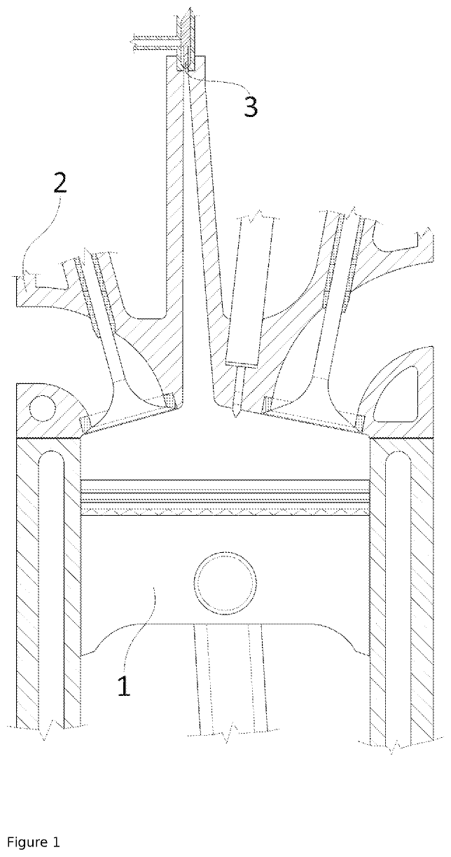

FIG. 2 represents a cross-section of the clearance volume of the engine with the combustion chamber (4) and the compression chamber (5).

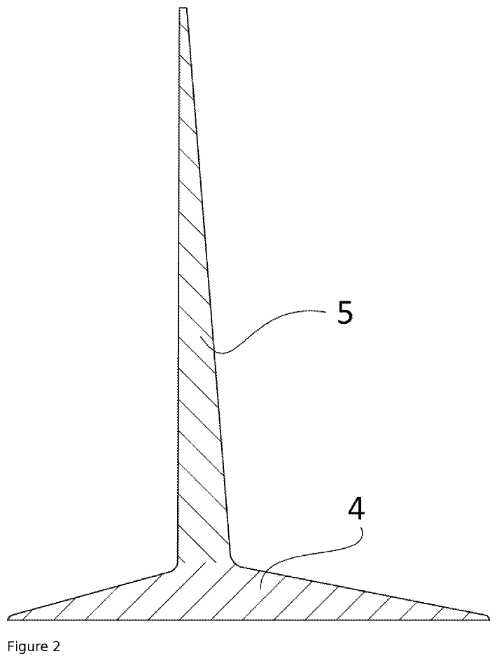

FIG. 3 represents the three-dimensional shape of the clearance volume of engine with the combustion chamber (4) and the compression chamber (5)

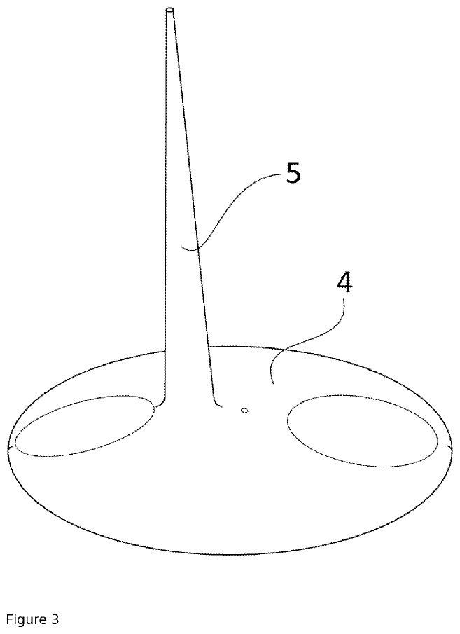

1. A system for internal combustion engine, where the process is to introduce a fluid said compression-fluid into the clearance volume, while ensuring a heterogeneous mixture at the moment of ignition of the combustion. Where is distinguished the part of the clearance volume essentially containing said compression-fluid and the part of the clearance volume do not containing the said compression-fluid.

2. According to claim 1, said system is characterized in that it comprises at least one chamber said the compression-chamber, and at least one valve or injector said the micro-valve at the end of said compression-chamber. The said compression-fluid is introduced into the said compression-chamber by the said micro-valve at predetermined quantities depending on various parameters as the load and engine speed. Said compression-chamber is in the form of a duct being part of the clearance volume and communicating with the combustion chamber. Said compression-chamber has a relatively small cross-section surface and/or may be equipped with fins to limit the mixing before ignition of the combustion, between said compression-fluid and the air or the air/fuel mixture.

3. According to claims 1 and 2, said system is characterized in that it use a compressor or compressors by which the said compression-fluid is compressed to recover a part of energy in the form of compressed compression-fluid when the vehicle brake, and/or when the internal combustion engine is idling or without an external load.

4. According to claims 1 and 2, said system is characterized in that it use a compressor or compressors as a variable additional load for the internal combustion engine to help the internal combustion engine to operate at its desired operating point.

5. According to claims 1 and 2, said system is characterized in that it use the air, the exhaust gases of the engine, the water or the di-nitrogen (N2) as said compression-fluid.

6. According to claims 1 and 2, said system is characterized in that it add the said compression-fluid to the air or to the air/fuel mixture, in order to reduce the percentage of di-oxygen (O2).

7. According to claims 1 and 2, said system is characterized in that it use the said compression-fluid as a heat-transfer fluid for recovering part of the heat energy produced by combustion of the air/fuel mixture.

8. According to claims 1 and 2, said system is characterized in that it use the said compression-fluid to actuate the internal combustion engine as a pneumatic motor, and/or the pneumatic systems of the internal combustion engine, and/or the pneumatic systems of the vehicle.
